(19) United States
(12) Patent Application Publication
(10) Pub. No.: US 2018/0048014 A1
(43) Pub. Date: Feb. 15, 2018

(54) NON-AQUEOUS ELECTROLYTE SECONDARY BATTERY

(71) Applicant: PANASONIC INTELLECTUAL PROPERTY MANAGEMENT CO. LTD., Osaka-shi, Osaka (JP)

(72) Inventors: Masanori Sugimori, Hyogo (JP); Katsunori Yanagida, Hyogo (JP); Natsumi Goto, Hyogo (JP)

(73) Assignee: PANASONIC INTELLECTUAL PROPERTY MANAGEMENT CO. LTD., Osaka-shi, Osaka (JP)

(21) Appl. No.: 15/549,448

(22) PCT Filed: Apr. 13, 2016
(86) PCT No.: PCT/JP2016/001996

§ 371 Date: Aug. 8, 2017

(30) Foreign Application Priority Data
Apr. 22, 2015 (JP) 2015-087410

(51) Int. Cl. H01M 10/052; H01M 2/16; H01M 4/62; H01M 4/36; H01M 4/485; H01M 10/0568; H01M 4/13

(52) U.S. Cl. CPC H01M 10/052; H01M 10/0568; H01M 2/1626; H01M 4/13; H01M 4/36; H01M 4/485; H01M 4/62; H01M 2004/027

(57) ABSTRACT

The present invention aims to provide a non-aqueous electrolyte secondary battery in which the amount of a gas generated during charge/discharge cycles, during storage, or the like is small although a cellulose-made separator is used. A non-aqueous electrolyte secondary battery which is one example of an embodiment includes a positive electrode including a positive electrode collector and a positive electrode mixture layer formed thereon; a negative electrode including a negative electrode collector and a negative electrode mixture layer formed thereon; a separator formed from a cellulose as a primary component; and a fluorine-containing non-aqueous electrolyte. In the positive electrode mixture layer, a lithium transition metal oxide and a phosphoric acid compound are contained.

### TECHNICAL FIELD

The present disclosure relates to a non-aqueous electrolyte secondary battery.

### BACKGROUND ART

Patent Literature 1 has disclosed a non-aqueous electrolyte secondary battery which uses as a negative electrode active material, a lithium titanate having a spinel structure, the surface of which is covered with a basic polymer. In Patent Literature 1, as a separator applicable to the secondary battery described above, a porous membrane formed from a cellulose has been disclosed. A separator formed from a cellulose as a primary component (hereinafter, referred to as “cellulose-made separator” or “cellulose separator” in some cases) is, for example, excellent not only in air permeability but also in heat resistance and is preferably used for a high output battery and the like.

### CITATION LIST

### Patent Literature

PTL 1: International Publication No. 2012/111546

### SUMMARY OF INVENTION

### Technical Problem

Incidentally, for example, compared to the case in which a polyolefin-made separator is used, a non-aqueous electrolyte secondary battery using a cellulose-made separator has a problem in that the amount of a gas generated during charge/discharge cycles and during storage is large.

### Solution to Problem

A non-aqueous electrolyte secondary battery according to one aspect of the present disclosure is a non-aqueous electrolyte secondary battery which comprises a positive electrode including a positive electrode collector and a positive electrode mixture layer formed thereon, a negative electrode including a negative electrode collector and a negative electrode mixture layer formed thereon, a separator formed from a cellulose as a primary component, and a fluorine-containing non-aqueous electrolyte, and in the positive electrode mixture layer, a lithium transition metal oxide and a phosphoric acid compound are contained.

### Advantageous Effects of Invention

According to one aspect of the present disclosure, although a cellulose-made separator is used, a non-aqueous electrolyte secondary battery which generates a small amount of a gas during charge/discharge cycles, storage, and the like is provided.

### BRIEF DESCRIPTION OF DRAWINGS

FIG. 1 is a cross-sectional view of a non-aqueous electrolyte secondary battery according to one example of an embodiment.

### DESCRIPTION OF EMBODIMENT

Although excellent in mechanical strength, air permeability, heat resistance, and the like, a cellulose-made separator has a hygroscopic property since a cellulose molecule contains many hydroxides. Hence, when the cellulose-made separator is used, the amount of moisture to be carried into a battery is increased, and when charge/discharge cycles are performed on the battery, or when the battery is stored, the amount of a gas to be generated is increased. Since the moisture carried into the battery by the cellulose-made separator reacts with a fluorine-containing non-aqueous electrolyte and generates hydrogen fluoride (HF), a metal component of a positive electrode active material is eluted by the HF thus generated, and corrosion of a positive electrode is advanced. Hence, it is believed that gases, such as H₂, CO, and CO₂, are generated.

Through intensive research carried out by the present inventors to solve the problem described above, it was finally found that when a phosphoric acid compound is contained in a positive electrode mixture layer, the gas generation of a non-aqueous electrolyte secondary battery using a cellulose-made separator can be specifically suppressed. The reason for this is believed that by the function of the phosphoric acid compound contained in the positive electrode mixture layer, a high-quality protective film is formed on the surface of a positive electrode active material from decomposed materials of an electrolyte, and the film thus formed prevents a metal component from being eluted form the positive electrode active material by HF, so that the gas generation is suppressed. In addition, since a separator formed form a resin other than a cellulose, such as a polyolefin-made separator, has a low hydroscopic property, in the case in which the separator described above is used, the gas generation caused by moisture carried into the battery as described above is not likely to occur. Hence, when a polyolefin-made separator is used, even if a phosphoric acid compound is added to the positive electrode mixture layer, the effect of suppressing the gas generation may be small or may be not obtained (see Reference Examples describe later).

When a group IV to VI oxide is used as a negative electrode active material, the amount of moisture to be carried into a battery is further increased, and a gas generation amount is liable to increase, for example, during charge/discharge cycles of the battery. In this specification, the group IV to VI oxide indicates an oxide containing at least one type of element selected from the group consisting of a group IV element, a group V element, and a group VI element of the periodic table. Although being excellent in stability at a high potential and having preferable characteristics as the negative electrode active material, the group IV to VI oxide contains many hydroxides, and when the BET specific surface area is increased, the number of water molecules to be hydrogen-bonded to the above hydroxides is increased, so that a large amount of moisture is adsorbed. Although the group IV to VI oxide is used, a non-aqueous electrolyte secondary battery according to one aspect of the present disclosure can sufficiently suppress the gas generation during charge/discharge cycles of the battery and during storage thereof.

Hereinafter, one example of an embodiment will be described in detail.

The drawing used for illustration of the embodiment is schematically drawn, and for example, a dimensional ratio of each constituent element shown in the drawing may be different from that of an actual element in some cases. A concrete dimensional ratio and the like are to be understood in consideration of the following description.

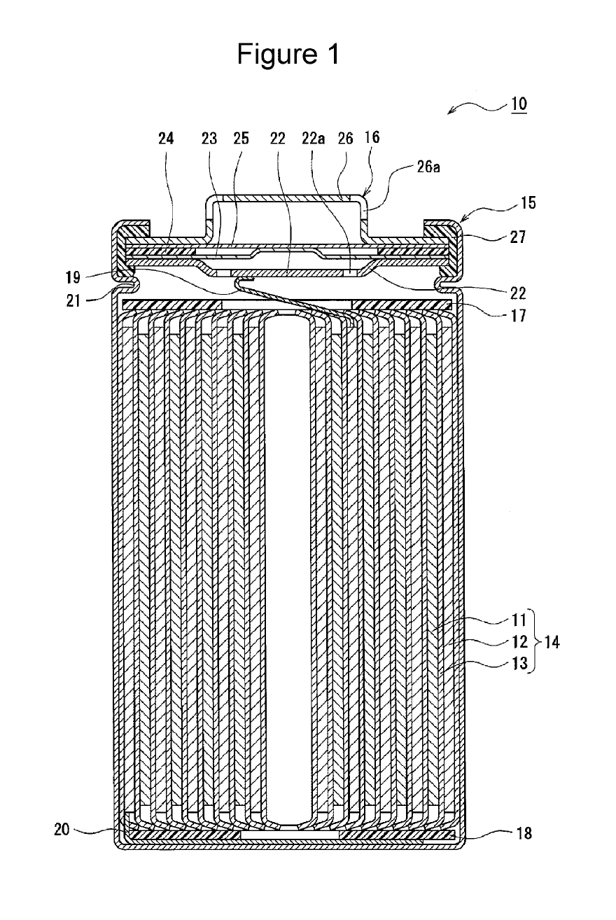

FIG. 1 is a cross-sectional view of a non-aqueous electrolyte secondary battery 10 which is one example of the embodiment.

The non-aqueous electrolyte secondary battery 10 comprises a positive electrode 11 including a positive electrode collector and a positive electrode mixture layer formed thereon, a negative electrode 12 including a negative electrode collector and a negative electrode mixture layer formed thereon, and a fluorine-containing non-aqueous electrolyte. Between the positive electrode 11 and the negative electrode 12, at least one separator 13 is preferably provided. The non-aqueous electrolyte secondary battery 10 has the structure in which a winding type electrode body 14 formed by winding the positive electrode 11 and the negative electrode 12 with the separator 13 interposed therebetween and the non-aqueous electrolyte are received in a battery case. Instead of the winding type electrode body 14, another electrode body, such as a lamination type electrode body formed by laminating positive electrodes and negative electrodes with separators interposed therebetween, may also be used. As the battery case receiving the electrode body 14 and the non-aqueous electrolyte, for example, there may be mentioned a metal-made case having a shape, such as a cylindrical, a square, a coin, or a button shape, or a resin-made case (laminate type battery) formed by laminating at least one resin sheet on metal foil. In the example shown in FIG. 1, the battery case is formed of a cylindrical case main body 15 having a bottom portion and a sealing body 16.

The non-aqueous electrolyte secondary battery 10 includes insulating plates 17 and 18 provided on a top and a bottom of the electrode body 14, respectively. In the example shown in FIG. 1, a positive electrode lead 19 fitted to the positive electrode 11 extends to a sealing body 16 side through a through-hole of the insulating plate 17, and a negative electrode lead 20 fitted to the negative electrode 12 extends to a bottom portion side of the case main body 15 along the outside of the insulating plate 18. For example, the positive electrode lead 19 is connected to a bottom surface of a filter 22, that is, to a bottom plate of the sealing body 16, by welding or the like, and a cap 26 which is a top plate of the sealing body 16 electrically connected to the filter 22 functions as a positive electrode terminal. The negative electrode lead 20 is connected to the inside of the bottom portion of the case main body 15 by welding or the like, and the case main body 15 functions as a negative electrode terminal. In this embodiment, for the sealing body 16, a current interruption device (CID) and a discharge mechanism (safety valve) are provided. In addition, a gas discharge valve is preferably provided for the bottom portion of the case main body 15.

The case main body 15 is, for example, a cylindrical metal-made container having a bottom portion. Between the case main body 15 and the sealing body 16, a gasket 27 is provided, so that the air tightness of the inside of the battery case can be secured. The case main body 15 preferably has a protrusion portion 21 formed, for example, by pressing a side surface portion from the outside so as to support the sealing body 16. The protrusion portion 21 is preferably formed to have a ring shape along the circumference direction of the case main body 15 and supports the sealing body 16 by the upper surface thereof.

The sealing body 16 includes the filter 22 in which a filter opening portion 22a is formed and a valve body disposed on the filter 22. The valve body blocks the filter opening portion 22a of the filter 22 and is fractured when the inside pressure of the battery is increased by heat generation caused by internal short circuit or the like. In this embodiment, as the valve body, a lower valve body 23 and an upper valve body 25 are provided, and an insulating member 24 disposed between the lower valve body 23 and the upper valve body 25 and the cap 26 having a cap opening portion 26a are further provided. The individual members forming the sealing body 16 each have, for example, a circular shape or a ring shape and are electrically connected to each other except the insulating member 24. In particular, the filter 22 and the lower valve body 23 are bonded to each other along the circumference portions thereof, and the upper valve body 25 and the cap 26 are also bonded to each other along the circumference portions thereof. The lower valve body 23 and the upper valve body 25 are bonded to each other at the central portions thereof, and between the circumference portions thereof, the insulating member 24 is provided. When the inside pressure is increased by heat generation caused by internal short circuit or the like, for example, the lower valve body 23 is fractured at a thin wall portion thereof, and the upper valve body 25 is swelled toward a cap 26 side thereby and is separated from the lower valve body 23, so that the electrical connection therebetween is interrupted.

[Positive Electrode]

A positive electrode is formed of a positive electrode collector, such as metal foil, and a positive electrode mixture layer formed thereon. For the positive electrode collector, for example, there may be used foil made of a metal, such as aluminum, stable in a potential range of the positive electrode or a film in which the metal mentioned above is disposed as a surface layer. In the positive electrode mixture layer, a lithium transition metal oxide and a phosphoric acid compound are contained, and furthermore, an electrically conductive agent and a binding material are preferably contained. It is believed that since the phosphoric acid compound is contained in the positive electrode mixture layer, a high-quality protective film is formed on the surface of the lithium transition metal oxide during charge, and the gas generation during charge/discharge cycles of the battery and during storage thereof is suppressed. The positive electrode can be formed, for example, in such a way that after a positive electrode mixture slurry containing the lithium transition metal oxide, the phosphoric acid compound, the electrically conductive agent, the binding material, and the like is applied onto the positive electrode collector, and coating films thus obtained are then dried, the positive electrode mixture layers are formed on two surfaces of the collector by rolling.

The lithium transition metal oxide functions as a positive electrode active material. As one example of a preferable lithium transition metal oxide, there may be mentioned an oxide containing as a transition metal, at least one selected from nickel (Ni), manganese (Mn), and cobalt (Co). In addition, the lithium transition metal oxide may contain a non-transition metal, such as aluminum (Al) or magnesium (Mg). As a metal element to be contained in the lithium transition metal oxide, besides Co, Ni, Mn, Al, and Mg, tungsten (W), boron (B), titanium (Ti), vanadium (V), iron (Fe), copper (Cu), zinc (Zn), niobium (Nb), zirconium (Zr), tin (Sn), tantalum (Ta), sodium (Na), potassium (K), barium (Ba), strontium (Sr), or calcium (Ca) may be mentioned by way of example.

As a particular example of the preferable lithium transition metal oxide, for example, lithium cobaltate or a composite oxide, such as a Ni—Co—Mn-based, a Ni—Co—Al-based, or a Ni—Mn—Al-based oxide, may be mentioned. The molar ratio of Ni, Co, and Mn of the Ni—Co—Mn-based lithium transition metal oxide is for example, 1:1:1, 5:2:3, 4:4:2, 5:3:2, 6:2:2, 55:25:20, 7:2:1, 7:1:2, or 8:1:1. In order to increase a positive electrode capacity, an oxide in which the rates of Ni and Co are each larger than that of Mn is preferably used, and in particular, an oxide in which the difference in molar rate between Ni and Mn to the total moles of Ni, Co, and Mn is 0.04% or more is preferable. The molar ratio of Ni, Co, and Al of the Ni—Co—Al-based lithium transition metal oxide is for example, 82:15:3, 82:12:6, 80:10:10, 80:15:5, 87:9:4, 90:5:5, or 95:3:2.

The lithium transition metal oxide preferably has a layered structure. However, the lithium transition metal oxide may also be an oxide, such as a lithium manganese oxide or a lithium nickel manganese oxide, having a spinel structure or an oxide having an olivine structure represented by LiMPO₄ (M: at least one selected from Fe, Mn, Co, and Ni). For the positive electrode active material, one type of lithium transition metal oxide may only be used, or at least two types thereof may be used by mixing.

The lithium transition metal oxide is for example, in the form of grains having an average grain diameter of 2 to 30 μm. The grains described above may be secondary grains formed by agglomerating primary grains having an average grain diameter of 100 nm to 10 μm. The average grain diameter of the lithium transition metal oxide is the median diameter (grain diameter obtained when the volume accumulation value of the grain distribution is 50%, hereinafter, referred to as “Dv50”) measured by a scattering grain size distribution measurement device (such as LA-750 manufactured by HORIBA, Ltd.).

In the lithium transition metal oxide, tungsten (W) is preferably solid-solved. Furthermore, to the surface of the lithium transition metal oxide, a tungsten oxide is preferably adhered. That is, W is preferably solid-solve in the lithium transition metal oxide, and in addition, to the surface of the metal oxide described above, a tungsten oxide is preferably adhered. Accordingly, for example, a more high-quality protective film is formed on the surface of the lithium transition metal oxide, and the gas generation during charge/discharge cycles of the battery and during storage thereof can be further suppressed. When a tungsten oxide is contained in the positive electrode mixture layer, that is, when a tungsten oxide is present in the vicinity of the lithium transition metal oxide, although the advantage described above may be expected, a tungsten oxide is more preferably present so as to be adhered to the surface of the lithium transition metal oxide.

The content of W to be solid-solved in the lithium transition metal oxide is preferably 0.01 to 3.0 percent by mole with respect to the total moles of the metal elements other than Li, more preferably 0.03 to 2.0 percent by mole, and particularly preferably 0.05 to 1.0 percent by mole. When the content of the solid-solved W is in the range described above, without decreasing the positive electrode capacity, a high-quality film is likely to be formed on the surface of the lithium transition metal oxide. The state in which W is solid-solved in the lithium transition metal oxide indicates the state in which W partially replaces Ni, Co, and/or the like in the metal oxide and is present therein (state in which W is present in the crystal).

The solid solution of W in the lithium transition metal oxide and the solid solution amount thereof may be confirmed by an analysis performed in such a way that after the grain is cut, or the surface thereof is polished, the inside of the grain is observed using an Auger electron spectroscopy (AES), a secondary ion mass spectrometry (SIMS), and/or a transmission electron microscope (TEM)-energy dispersive X-ray spectrometry (EDX).

As a method in which W is solid-solved in the lithium transition metal oxide, for example, there may be mentioned a method in which a composite oxide containing Ni, Co, Mn, and the like, a lithium compound, such as lithium hydroxide or lithium carbonate, and a tungsten compound, such as a tungsten oxide, are mixed together and then fired. A firing temperature is preferably 650° C. to 1,000° C. and particularly preferably 700° C. to 950° C. When the firing temperature is less than 650° C., for example, a decomposition reaction of lithium hydroxide is not sufficient, and the reaction may not be likely to proceed in some cases. When the firing temperature is more than 1,000° C., for example, cation mixing is activated, and for example, a decrease in specific capacity and a degradation in load characteristics may occur in some cases.

The content of the tungsten oxide contained in the positive electrode mixture layer on the W element basis is with respect to the total moles of the metal elements other than Li of the lithium transition metal oxide, preferably 0.01 to 3.0 percent by mole, more preferably 0.03 to 2.0 percent by mole, and particularly preferably 0.05 to 1.0 percent by mole. Most of the tungsten oxide is preferably adhered to the grain surfaces of the lithium transition metal oxide. That is, the content of the tungsten oxide adhered to the surface of the lithium transition metal oxide on the W element basis is preferably 0.01 to 3.0 percent by mole with respect to the total moles of the metal elements other than Li of the metal oxide described above. When the content of the tungsten oxide is within the range described above, without decreasing the positive electrode capacity, a high-quality film is likely to be formed on the surface of the lithium transition metal oxide.

The tungsten oxide is preferably dispersedly adhered to the surface of the lithium transition metal oxide. The tungsten oxide is not locally present by agglomeration on parts of the surface of the lithium transition metal oxide and is uniformly adhered to the entire surface thereof. As the tungsten oxide, for example, WO₃, WO₂, and W₂O₃ may be mentioned. Among those compounds mentioned above, WO₃ is preferable since having a most stable hexavalent value as the oxidation number of W.

The average grain diameter of the tungsten oxide is preferably smaller than that of the lithium transition metal oxide and in particular, is preferably smaller than one fourth thereof. When the average grain diameter of the tungsten oxide is larger than that of the lithium transition metal oxide, the contact area to the lithium transition metal oxide is decreased, and as a result, the above advantage may not be sufficiently obtained in some cases. The average grain diameter of the tungsten oxide adhered to the surface of the lithium transition metal oxide may be measured using a scanning electron microscope (SEM). In particular, from a SEM image of positive electrode active material grains (lithium transition metal oxide having a surface to which the tungsten oxide is adhered), after 100 grains of the tungsten oxide are randomly selected, and the maximum major axes of the grains are measured, the average of the measured data is regarded as the average grain diameter. The average grain diameter of the tungsten oxide measured by the method described above is for example, 100 nm to 5 μm and preferably 100 nm to 1 μm.

As a method to adhere the tungsten oxide to the surface of the lithium transition metal oxide, for example, there may be mentioned a method in which the lithium transition metal oxide and the tungsten oxide are mechanically mixed with each other. Alternatively, in a step of forming a positive electrode mixture slurry, the tungsten oxide is added to a slurry raw material, such as the positive electrode active material, so that the tungsten oxide is adhered to the surface of the lithium transition metal oxide. In order to increase the amount of the tungsten oxide adhered to the surface of the lithium transition metal oxide, the former method is preferably used.

In the positive electrode mixture layer, the phosphoric acid compound is contained as described above. The phosphoric acid compound forms a high-quality protective film on the surface of the lithium transition metal oxide. As the phosphoric acid compound, for example, there may be mentioned lithium phosphate, lithium dihydrogen phosphate, cobalt phosphate, nickel phosphate, manganese phosphate, potassium phosphate, calcium phosphate, sodium phosphate, magnesium phosphate, ammonium phosphate, or ammonium dihydrogen phosphate. Those phosphoric acid compounds may be used alone, or at least two types thereof may be used by mixing. In consideration of the stability of the phosphoric acid compound in an overcharge state of the battery and the like, a lithium phosphate is preferably used. As the lithium phosphate, for example, although lithium dihydrogen phosphate, lithium hydrogen phosphite, lithium monofluorophosphate, or lithium difluorophosphate may be mentioned, Li₃PO₄ is preferable. The lithium phosphate is for example, in the form of grains having a Dv50 of 50 nm to 10 μm and is preferably in the form of grains having a Dv50 of 100 nm to 1 μm.

The content of the phosphoric acid compound in the positive electrode mixture layer is preferably 0.1 to 5.0 percent by mass with respect to the mass of the positive electrode active material, more preferably 0.5 to 4.0 percent by mass, and particularly preferably 1.0 to 3.0 percent by mass. When the content of the phosphoric acid compound is in the range described above, without decreasing the positive electrode capacity, a high-quality film is likely to be formed on the surface of the lithium transition metal oxide, and during charge/discharge cycles and during storage, the gas generation can be efficiently suppressed.

As a method in which the phosphoric acid compound is contained in the positive electrode mixture layer, for example, a method for adding the phosphoric acid compound to the positive electrode mixture layer may be performed by mechanically mixing in advance, the phosphoric acid compound and the lithium transition metal oxide having a surface to which the tungsten oxide is adhered. Alternatively, in a step of forming the positive electrode mixture slurry, a lithium phosphate may be added to a slurry raw material, such as the positive electrode active material.

As the electrically conductive agent contained in the positive electrode mixture layer, carbon materials, such as carbon black, acetylene black, ketchen black, graphite, vapor grown carbon (VGCF), carbon nanotubes, and carbon nanofibers, may be mentioned. Those materials may be used alone, or at least two types thereof may be used in combination.

As the binding material contained in the positive electrode mixture layer, for example, there may be mentioned a fluorine resin, such as a polytetrafluoroethylene (PTFE) or a poly(vinylidene fluoride) (PVdF), a polyolefin resin, such as an ethylene-propylene-isoprene copolymer or an ethylene-propylene-butadiene copolymer, a polyacrylonitrile (PAN), a polyimide resin, or an acrylic resin. In addition, together with at least one of the resins mentioned above, for example, a carboxymethyl cellulose (CMC) or its salt (such as CMC-Na, CMC-K, CMC-NH₄, or its partially neutralized salt), or a poly(ethylene oxide) (PEO) may also be used. Those compounds may be used alone, or at least two types thereof may be used in combination.

[Negative Electrode]

A negative electrode is formed of a negative electrode collector, such as metal foil, and a negative electrode mixture layer formed thereon. For the negative electrode collector, for example, there may be used foil made of a metal, such as copper, stable in a potential range of the negative electrode or a film in which the metal mentioned above is disposed as a surface layer. Although the negative electrode collector may be copper foil, nickel foil, stainless steel foil, or the like, when a group IV to VI oxide is used as a negative electrode active material, aluminum foil is preferable. The negative electrode mixture layer preferably contains a binding material besides the negative electrode active material, and when the group IV to VI oxide is used as the negative electrode active material, an electrically conductive agent is preferably further contained. The negative electrode may be formed, for example, in such a way that after a negative electrode mixture slurry containing the negative electrode active material, the binding material, and the like is applied onto the negative electrode collector, and coating films thus obtained are then dried, the negative electrode mixture layers are formed on two surfaces of the collector by rolling.

For the negative electrode active material, for example, a group IV to VI oxide may be used. The group IV to VI oxide is an oxide containing at least one selected from a group IV element, a group V element, and a group VI element of the periodic table as described above. Although being excellent in stability at a high potential as described above and having preferable characteristics as the negative electrode active material, the group IV to VI oxide absorbs a large amount of moisture since having many hydroxyl groups.

As the group IV element, the group V element, and the group VI element of the element periodic table forming the group IV to VI oxide, for example, titanium (Ti), zirconium (Zr), hafnium (Hf), vanadium (V), niobium (Nb), tantalum (Ta), chromium (Cr), molybdenum (Mo), or tungsten (W) may be mentioned. For the group IV to VI oxide, at least one type oxide selected from a titanium oxide containing Ti, a niobium oxide containing Nb, and a tungsten oxide containing W is preferably used, and among those oxides mentioned above, the titanium oxide is particularly preferable.

As the titanium oxide described above, for example, there may be mentioned titanium dioxide (TiO₂) or a lithium-containing titanium oxide. In view of output characteristics of the battery, the stability during charge/discharge, and the like, a lithium-containing titanium oxide is preferably used, and in particular, a lithium titanate is more preferable, and a lithium titanate having a spinel crystal structure is particularly preferable. The lithium titanate having a spinel crystal structure is for example, represented by Li₄₊ₓ, Ti₅O₁₂ (0≦X≦3). Ti of a lithium titanate may be partially replaced by at least one another element. The lithium titanate having a spinel crystal structure has a small expansion/contraction in association with insertion and release of lithium ions and is not likely to be degraded. Hence, when the oxide described above is used for the negative electrode active material, a battery having an excellent durability can be obtained. The spinel structure of a lithium titanate may be confirmed, for example, by an X-ray diffraction measurement.

The group IV to VI oxide (lithium titanate) is, for example, in the form of grains having a Dv50 of 0.1 to 10 μm. The BET specific surface area of the group IV to VI oxide is preferably 2 m²/g or more, more preferably 3 m²/g or more, and particularly preferably 4 m²/g or more. The BET specific surface area may be measured by a BET method using a specific surface area measurement device (such as Tristar II 3020 manufactured by Shimadzu Corporation). When the specific surface area of the group IV to VI oxide is less than 2 m²/g, input/output characteristics of the battery tends to be insufficient. In addition, since the amount of moisture carried into the battery is decreased, the effect of suppressing the gas generation of the present invention is decreased. On the other hand, when the specific surface area of the group IV to VI oxide is excessively increased, the crystallinity of the group IV to VI oxide is degraded, and the durability is liable to be degraded; hence, the specific surface area is preferably 8 m²/g or less.

As the negative electrode active material, the group IV to VI oxide, in particular, a lithium titanate, is preferably used alone. However, the group IV to VI oxide may also be used by mixing with another negative electrode active material. As the negative electrode active material, any material may be used without any particular restriction as long as being capable of reversibly inserting and releasing lithium ions, and for example, there may be used a carbon material, such as natural graphite or artificial graphite; a metal, such as silicon (Si) or tin (Sn), forming an alloy with lithium; or an alloy or a composite oxide, each of which contains a metal element, such as Si or Sn. When the group IV to VI oxide is used by mixing with another negative electrode active material, the content of the group IV to VI oxide is preferably 80 percent by mass or more with respect to the total mass of the negative electrode active material.

As the electrically conductive agent contained in the negative electrode mixture layer, for example, a carbon material similar to that of the positive electrode may be used. As the binding material contained in the negative electrode mixture layer, as is the case of the positive electrode, for example, a fluorinated resin, a PAN, a polyimide resin, an acrylic resin, or a polyolefin resin may be used. When a mixture slurry is prepared using an aqueous solvent, for example, there may be preferably used a CMC or its salt (such as CMC-Na, CMC-K, CMC-NH₄, or a partially neutralized salt thereof), a styrene-butadiene rubber (SBR), a polyacrylic acid (PAA) or its salt (such as PAA-Na, PAA-K, or a partially neutralized salt thereof), or a poly(vinyl alcohol) (PVA).

[Separator]

The separator is a porous membrane having an ion permeability and an insulating property and is a cellulose separator formed from a cellulose as a primary component. Although excellent in mechanical strength, air permeability, heat resistance, and the like as described above, the cellulose separator has a hygroscopic property since a cellulose molecule has many hydroxyl groups. The cellulose separator is a non-woven cloth formed, for example, from cellulose fibers as a primary component. In addition, the case in which a cellulose (cellulose fibers) is used as a primary component indicates that the mass ratio of the cellulose with respect to constituent materials of the separator is highest, and that the content of the cellulose is 80 percent by mass or more with respect to the total mass of the separator. The cellulose separator may also contain organic fibers other than the cellulose fibers, such as aramid fibers, polyolefin fibers, polyamide fibers, and/or polyamide fibers and may also contain fine grains of silica, alumina, and/or the like. The cellulose separator may be substantially formed only from a cellulose.

In consideration of the mechanical strength, the ion permeability, and the like, the thickness of the cellulose separator is preferably 5 to 30 μm and more preferably 10 to 25 μm. The thickness of the separator may be measured, for example, by observation using a micrometer or an electron microscope (such as a SEM or a TEM). A void rate of the cellulose separator is preferably 65% to 90% and more preferably 70% to 85%. The void rate of the separator indicates the rate of the total volume of pores with respect to the total volume of the separator and may be obtained from the following formula (1).

Void Rate (%)=(1−Apparent Density/True Density)×100 Formula (1)

In the cellulose separator, the mode diameter (maximum frequency) in the pore diameter distribution preferably corresponds to a pore diameter of less than 0.5 μm, and pores having a pore diameter of 1 μm or less preferably occupy 80% or more of the pore volume. The pore diameter distribution of the separator may be measured by a bubble point method (JIS K3832 or ASTM F316-86). In particular, the measurement may be performed by using a Palm Porometer (such as CFP-1500AE type manufactured by Seika Corporation) and SILWICK (20 dyne/cm) or GALKWICK (16 dyne/cm) each of which is a solvent having a low surface tension. When dry air is pressurized to a measurement pressure of 3.5 Mpa, pores having a size down to 0.01 m can be measured, and from an air permeation amount at the measurement pressure, the pore diameter distribution may be obtained.

Although not particularly limited, the air permeability of the cellulose separator is, for example, 1 second/100 cc to 20 seconds/100 cc. The air permeability of the separator may be measured by a Gurley densometer or the like. Although not particularly limited, the amount per unit area of the separator is, for example, 5 to 20 g/m².

[Non-Aqueous Electrolyte]

As the non-aqueous electrolyte, a fluorine-containing non-aqueous electrolyte containing fluorine (F) is used. The fluorine-containing non-aqueous electrolyte contains for example, a non-aqueous solvent and a fluorine-containing electrolyte salt (solute) dissolved therein. The non-aqueous electrolyte is not limited to a liquid electrolyte (non-aqueous electrolyte liquid) and may be a solid electrolyte using a gel polymer or the like. The non-aqueous solvent may be a halogen substitute in which at least one hydrogen atom of a solvent molecule is replaced by a halogen atom, such as a fluorine atom.

As the non-aqueous solvent, for example, there may be used a cyclic carbonate, such as ethylene carbonate, propylene carbonate, butylene carbonate, or vinylene carbonate; or a chain carbonate, such as dimethyl carbonate, ethyl methyl carbonate, or diethyl carbonate. In particular, in order to suppress the gas generation, a cyclic carbonate is preferably contained. By the use of a cyclic carbonate, since a high-quality film is formed on the surface of the lithium transition metal oxide, corrosion of the positive electrode active material and metal elution, each of which is caused by HF, are suppressed, so that the gas generation during charge/discharge cycles and during storage can be further suppressed.

As the cyclic carbonate, propylene carbonate is preferably used. Since propylene carbonate is not likely to be decomposed, the gas generation amount can be reduced. In addition, by the use of propylene carbonate, excellent low-temperature input/output characteristics can be obtained. When a carbon material is used as the negative electrode active material, if polypropylene carbonate is contained, since an irreversible charge reaction may occur in some case, together with propylene carbonate, for example, ethylene carbonate and/or fluoroethylene carbonate is preferably used. On the other hand, when a lithium titanate is used as the negative electrode active material, since an irreversible charge reaction is not likely to occur, the rate of propylene carbonate occupied in the cyclic carbonate is preferably large. For example, the rate of polypropylene carbonate occupied in the cyclic carbonate is 80 percent by volume or more or is more preferably 90 percent by volume or more, and may also be 100 percent by volume.

In order to decrease the viscosity, decrease the melting point, improve the lithium ion conductivity, and the like, as the non-aqueous solvent, a mixed solvent of the cyclic carbonate and the chain carbonate is preferably used. The volume ratio of the cyclic carbonate to the chain carbonate in this mixed solvent is preferably in a range of 2:8 to 5:5.

Together with the solvent described above, a compound containing an ester, such as methyl acetate, ethyl acetate, propyl acetate, methyl propionate, ethyl propionate, or γ-butyrolactone may be used. In addition, for example, a compound containing a sulfone group, such as propane sultone, a compound containing an ether, such as 1,2-dimethoxyethane, 1,2-diethoxyethane, tetrahydrofuran, 1,3-dioxane, 1,4-dioxane, or 2-methyltetrahydrofuran, a compound containing a nitrile, such as butyronitrile, valeronitrile, n-heptane nitrile, succinonitrile, glutaronitrile, adiponitrile, pimelonitrile, 1,2,3-propane tricarbonitrile, or 1,3,5-pentane tricarbonitrile, or a compound containing an amide, such as dimethylformamide, may also be used together with the solvent mentioned above.

As the electrolyte salt, a fluorine-containing lithium salt is preferably used. As the fluorine-containing lithium salt, for example, there may be mentioned LiPF₆, LiBF₄, LiCF₃SO₃, LiN(FSO₂)₂, LiN(CF₃SO₂)₂, LiN(C₂F₅SO₂)₂, LiN(CF₃SO₂) (C₄F₉SO₂), LiC(C₂F₅SO₂)₃, or LiAsF₆. Besides the fluorine-containing lithium salt, a lithium salt [lithium salt (such as LiClO₄ or LiPO₂F₂) containing at least one type of element selected from P, B, O, S, N, and Cl] other than the fluorine-containing lithium salt may also be added. The concentration of the electrolyte salt is preferably set to 0.8 to 1.8 moles per one liter of the non-aqueous solvent.

### EXPERIMENTAL EXAMPLES

Hereinafter, although the present disclosure will be further described with reference to Experimental Examples, the present disclosure is not limited to the following Experimental Examples.

### Experimental Example 1

[Formation of Positive Electrode Active Material]

A hydroxide represented by [Ni_{0.50}Co_{0.20}Mn_{0.30}] (OH)₂ obtained by co-precipitation was fired at 500° C., so that a nickel cobalt manganese composite oxide was obtained. Next, lithium carbonate, the nickel cobalt manganese composite oxide described above, and a tungsten oxide (WO₃) were mixed together using an Ishikawa type grinding mortar so that the molar ratio of Li, the total of Ni, Co, and Mn, and W in WO₃ was 1.2:1:0.005. This mixture was heat-treated at 900° C. for 20 hours in an air atmosphere and then pulverized, so that a lithium transition metal oxide represented by Li_{1.07}[Ni_{0.465}Co_{0.186} Mn_{0.279}W_{0.005}]O₂ in which tungsten was solid-solved was obtained. By observation of a powder of the composite oxide thus obtained using a scanning electron microscope (SEM), it was confirmed that no un-reacted product of the tungsten oxide remained.

The above lithium transition metal oxide and a tungsten oxide (WO₃) were mixed with each other using a Hivis Disper Mix (manufactured by Primix Corporation), so that a positive electrode active material in which WO₃ was adhered to the surface of the lithium transition metal oxide was formed. In this case, mixing was performed so that the molar ratio of the metal elements (Ni, Co, Mn, and W) other than Li in the lithium transition metal oxide to W in WO₃ was 1:0.005.

[Formation of Positive Electrode]

The above positive electrode active material and a lithium phosphate (Li₃PO₄) in an amount of 2 percent by mass with respect to that of the active material were mixed together. The mixture thus obtained, acetylene black, and a poly(vinylidene fluoride) were mixed together at a mass ratio of 93.5:5:1.5, and after an appropriate amount of N-methyl-2-pyrrolidone was added thereto, kneading was performed, so that a positive electrode mixture slurry was prepared. After the positive electrode mixture slurry thus prepared was applied onto two surfaces of a positive electrode collector formed of aluminum foil, and coating films thus formed were then dried, rolling was performed using a rolling roller machine, and an aluminum-made collector tab was further fitted, so that a positive electrode in which positive electrode mixture layers were formed on the two surfaces of the positive electrode collector was formed. By observation of the positive electrode thus obtained using a SEM, it was confirmed that tungsten oxide grains having an average grain diameter of 150 nm were adhered to grain surfaces of the lithium transition metal oxide.

[Formation of Negative Electrode Active Material]

Raw material powders, LiOH.H₂O which was a commercially available reagent and TiO₂, were weighed so that the molar ratio of Li to Ti was set slightly larger than the stoichiometric ratio, that is, so as to be slightly Li-rich, and were then mixed together using a mortar. For the TiO₂ used as a raw material, a TiO₂ having an anatase crystal structure was used. After the raw material powders thus mixed together were placed in an Al₂O₃-made crucible and then heat-treated at 850° C. for 12 hours in an air atmosphere, a material thus heat-treated was pulverized using a mortar, so that a crude powder of a lithium titanate (Li₄Ti₅O₁₂) was obtained. By powder X-ray diffraction measurement of the crude powder of Li₄Ti₅O₁₂ thus obtained, a single phase diffraction pattern of a spinel structure which belonged to an Fd3m space group was obtained. The crude powder of Li₄Ti₅O₁₂ was processed by jet-mill pulverization and classification, so that a Li₄Ti₅O₁₂ powder having a Dv50 of 0.7 μm was obtained. This Li₄Ti₅O₁₂ powder was used as a negative electrode active material. The BET specific surface area of the Li₄Ti₅O₁₂ powder measured by a specific surface area measurement device (Tristar II 3020 manufactured by Shimadzu Corporation) was 6.8 m²/g.

[Formation of Negative Electrode]

After the above negative electrode active material, carbon black, and a poly(vinylidene fluoride) were mixed together at a mass ratio of 100:7:3, and an appropriate amount of N-methyl-2-pyrrolidone was added thereto, kneading was performed, so that a negative electrode mixture slurry was prepared. After the negative electrode mixture slurry described above was applied onto two surfaces of a negative electrode collector formed of aluminum foil, and coating films thus formed were dried, rolling was performed using a rolling roller machine, and a nickel-made collector tab was further fitted, so that a negative electrode in which negative electrode mixture layers were formed on the two surfaces of the negative electrode collector was formed.

[Preparation of Non-Aqueous Electrolyte]

In a mixed solvent obtained by mixing propylene carbonate (PC), ethyl methyl carbonate (EMC), and dimethyl carbonate (DMC) at a volume ratio of 25:35:40, LiPF₆ was dissolved at a rate of 1.2 moles/liter, so that a fluorine-containing non-aqueous electrolyte was prepared.

[Formation of Battery]

The positive electrode and the negative electrode were wound with at least one cellulose separator interposed therebetween and then vacuum-dried at 105° C. for 150 minutes, so that a winding type electrode body was formed. The cellulose separator was a non-woven cloth formed from cellulose fibers, and the thickness, the void rate, and the air permeability thereof were 20 μm, 75%, and 8 seconds/100 cc, respectively. In a glove box in an argon atmosphere, the electrode body and the non-aqueous electrolyte were sealed in an outer package formed of an aluminum laminate sheet, so that a battery A1 was formed. A design capacity of the battery A1 was 15.6 mAh.

### Experimental Example 2

In the formation of the positive electrode, except that Li₃PO₄ was not mixed, a battery A2 was formed in a manner similar to that of the above Experimental Example 1.

[Evaluation of Gas Generation Amount]

After Charge/discharge was performed 20 cycles on the batteries A1 and A2 under the following conditions, the batteries were stored for 3 days, and the gas generation amounts thereof were then obtained.

(Charge/Discharge Conditions)

Charge/discharge conditions for the first cycle: In a temperature environment of 25° C., constant current charge was performed at a charge current of 0.22 It (3.5 mA) to a battery voltage of 2.65 V, and next, constant current discharge was performed at a discharge current of 0.22 It (3.5 mA) to 1.5 V.

Charge/discharge conditions for the second to 20th cycle: In a temperature environment of 25° C., constant current charge was performed at a charge current of 2.3 It (36 mA) to a battery voltage of 2.65 V, and furthermore, constant voltage charge was performed at a constant battery voltage of 2.65 V to a current of 0.03 It (0.5 mA). Next, constant current discharge was performed at a discharge current of 2.3 It (36 mA) to 1.5 V.

In addition, a rest interval between the charge and the discharge was set to 10 minutes.

(Storage Conditions)

After the above charge/discharge were performed 20 cycles, in a temperature environment of 25° C., constant current charge was performed to 2.65 V. Subsequently, the battery was statically left in a temperature environment of 60° C. for 3 days and was then further discharged in a temperature environment of 25° C.

(Calculation of Gas Generation Amount)

Before the charge/discharge and after the storage test, the difference between the battery mass in the air and that in water was measured for each battery, and the buoyancy (volume) of the battery was calculated. The difference in buoyancy before the charge/discharge test and after the storage test was regarded as the gas generation amount.

TABLE 1

| Battery | Li₃PO₄ | Separator | Gas Generation Amount (cm³) |
|---|---|---|---|
| A1 | Yes | Cellulose-made | 2.1 |
| A2 | No | Cellulose-made | 2.8 |

In the battery A1 in which a lithium phosphate (Li₃PO₄) was mixed in the positive electrode, compared to the battery A2 in which no lithium phosphate was mixed, the gas generation amount was small.

In the battery A1, it is believed that since a lithium phosphate is present in the positive electrode mixture layer, oxidation decomposition of the electrolyte liquid at the surface of the positive electrode active material is promoted, and a high-quality film having an excellent function to protect the positive electrode active material from HF is formed from decomposed materials, so that the gas generation amount is decreased. On the other hand, in the battery A2, it is believed that since a high-quality film is not formed on the surface of the positive electrode active material, the positive electrode active material is corroded by HF, and as a result, the gas generation amount is increased.

### Reference Example 1

In the formation of the battery, except that a fine porous film having a three-layered structure formed of a polypropylene (PP)/a polyethylene (PE)/a polypropylene (PP) was used as the separator, a battery B1 was formed in a manner similar to that of Experimental Example 1, and the gas generation amount after the above storage test was obtained.

### Reference Example 2

In the formation of the positive electrode, except that Li₃PO₄ was not mixed, a battery B2 was formed in a manner similar to that of the above Reference Example 1, and the gas generation amount after the above storage test was obtained.

TABLE 2

| Battery | Li₃PO₄ | Separator | Gas Generation Amount (cm³) |
|---|---|---|---|
| B1 | Yes | Polyolefin-made | 0.6 |
| B2 | No | Polyolefin-made | 0.6 |

In the battery B1, as is the case of the battery A1, it is believed that since a lithium phosphate is present in the positive electrode mixture layer, oxidation decomposition of the electrolyte liquid at the surface of the positive electrode active material is promoted, and a film which protects the positive electrode active material from HF is formed. In this case, it is believed that compared to the film formed in the battery B2 from decomposed materials, the film formed in the battery B1 is likely to protect the positive electrode active material from HF; however, in the batteries B1 and B2, since the polyolefin-made separator is used, the amount of moisture to be carried into the battery is small, and hence the generation of HF is also suppressed. Accordingly, it is believed that the effect obtained by addition of a lithium phosphate is small.

That is, when a cellulose separator is used, and a lithium phosphate is mixed in the positive electrode, the gas generation can be specifically suppressed.

### REFERENCE SIGNS LIST

10 non-aqueous electrolyte secondary battery, 11 positive electrode, 12 negative electrode, 13 separator, 14 electrode body, 15 case main body, 16 sealing body, 17, 18 insulating plate, 19 positive electrode lead, 20 negative electrode lead, 22 filter, 22a filter opening portion, 23 lower valve body, 24 insulating member, 25 upper valve body, 26 cap, 26a cap opening portion, 27 gasket

1-6. (canceled)

7. A non-aqueous electrolyte secondary battery comprising: a positive electrode including a positive electrode collector and a positive electrode mixture layer formed thereon; a negative electrode including a negative electrode collector and a negative electrode mixture layer formed thereon; a separator formed from a cellulose as a primary component; and a fluorine-containing non-aqueous electrolyte,
wherein in the positive electrode mixture layer, a lithium transition metal oxide and a phosphoric acid compound are contained, and
wherein in the lithium transition metal oxide, tungsten is solid-solved, and to a surface of the lithium transition metal oxide, a tungsten oxide is adhered.

8. The non-aqueous electrolyte secondary battery according to claim 7, wherein in the negative electrode mixture layer, a group IV to VI oxide containing at least one type of element selected from a group IV element, a group V element, and a group VI element of the periodic table is contained.

9. The non-aqueous electrolyte secondary battery according to claim 8, wherein the group IV to VI oxide is a lithium titanate.

10. The non-aqueous electrolyte secondary battery according to claim 7, wherein the phosphoric acid compound is a lithium phosphate.

11. The non-aqueous electrolyte secondary battery according to claim 7, wherein the tungsten oxide is WO₃.

12. The non-aqueous electrolyte secondary battery according to claim 7,
wherein in the negative electrode mixture layer, a group IV to VI oxide containing at least one type of element selected from a group IV element, a group V element, and a group VI element of the periodic table is contained,
wherein the group IV to VI oxide is a lithium titanate,
wherein the phosphoric acid compound is a lithium phosphate, and
wherein the tungsten oxide is WO₃.
